(19) United States
(12) Patent Application Publication
(10) Pub. No.: US 2026/0330911 A1
(43) Pub. Date: Oct. 22, 2026

(54) METHOD FOR CONTROLLING MONEY HANDLING APPARATUS AND MONEY HANDLING APPARATUS

(71) Applicant: GLORY LTD., Himeji-shi (JP)

(72) Inventors: Tsuyoshi IZUMIDA, Himeji-shi (JP); Yoshitomo MINAMI, Himeji-shi (JP); Yoshifumi MASUDA, Himeji-shi (JP); Naoki KAMADA, Himeji-shi (JP)

(73) Assignee: GLORY LTD., Himeji-shi (JP)

(21) Appl. No.: 19/529,179

(22) Filed: Feb. 4, 2026

(30) Foreign Application Priority Data
Feb. 6, 2025 (JP) 2025-018640

(51) Int. Cl. G07D 9/02; G07D 11/18

(52) U.S. Cl. CPC G07D 9/02; G07D 11/18; G07D 2201/00; G07D 2211/00

(57) ABSTRACT

The method for controlling a money handling apparatus includes: causing the money handling apparatus to store money in a first storage that stores and feeds money; causing the money handling apparatus to store money in a second storage that stores and feeds money; and causing the money handling apparatus to selectively perform a first collection process or a second collection process when performing a collection process of collecting money from the money handling apparatus. The first collection process is a process in which the money handling apparatus dispenses, to an outlet, money fed from the first storage and money fed from the second storage. The second collection process is a process in which the money handling apparatus consolidates money in the money handling apparatus into the first storage by moving money from the second storage to the first storage.

### CROSS-REFERENCE TO RELATED APPLICATION

This application claims priority to Japanese Patent Application No. 2025-018640 filed on Feb. 6, 2025, the entire disclosure of which is incorporated by reference herein.

### BACKGROUND

In a conventional coin handling apparatus, a dispenser box and a collection cassette can be selectively loaded into a loading section. When the coin handling apparatus performs a dispensing process, the dispenser box is loaded into the loading section, and the coin handling apparatus sends coins for dispensing to the dispenser box. When the coin handling apparatus performs a collection process, the collection cassette is loaded into the loading section, and the coin handling apparatus sends coins for collection to the collection cassette.

The dispenser box is a box having an open top. When the collection cassette is removed from the loading section, the opening at its top is closed by a shutter.

### SUMMARY

The technology disclosed herein relates to a method for controlling a money handling apparatus. The method includes: causing the money handling apparatus to store money in a first storage that stores and feeds money; causing the money handling apparatus to store money in a second storage that stores and feeds money; and causing the money handling apparatus to selectively perform a first collection process or a second collection process when performing a collection process of collecting money from the money handling apparatus.

### BRIEF DESCRIPTION OF THE DRAWINGS

FIG. 1 shows an external appearance of a money handling apparatus.

FIG. 2 shows an internal structure of a coin handling unit.

FIG. 3 shows an internal structure of a banknote handling unit.

FIG. 4 shows a transport path of coins during a first collection process.

FIG. 5 shows a transport path of coins in a first step of a second collection process.

FIG. 6 shows, as a second step of the second collection process, removal of a first storage from the coin handling unit.

FIG. 7 shows an operation of the coin handling unit in a third step of the second collection process.

FIG. 8 is an exploded view of a housing of the money handling apparatus

FIG. 9 is an enlarged view of a connection portion between an upper housing and a lower housing.

FIG. 10 is an enlarged perspective view showing screw holes of the upper housing.

FIG. 11 is a diagram comparing a money handling apparatus having a large overall height and a money handling apparatus having a small overall height.

FIG. 12 shows an interlock circuit of the money handling apparatus.

FIG. 13 shows an interlock switch mounted at the rear of the banknote processing unit.

FIG. 14 shows removal of a cassette from the banknote processing unit.

FIG. 15 shows an interlock switch of a money processing apparatus including a second housing.

### DETAILED DESCRIPTION OF THE DRAWINGS

As the number of banknotes and coins to be collected from a money handling apparatus increases, the time required for the collection process becomes longer. It is desirable to reduce the time required for the collection process.

In a conventional coin handling apparatus, a dispensing process and a collection process are common in that coins are dispensed from the coin handling apparatus. The difference is whether a dispenser box or a collection cassette is loaded into a loading section. Accordingly, if the number of coins to be dispensed is the same, the time required for a dispensing process and the time required for a collection process are substantially the same. The conventional coin handling apparatus has no function to reduce the time required for a collection process.

The technology disclosed herein reduces the time required for a collection process of a money handling apparatus.

The technology disclosed herein relates to a method for controlling a money handling apparatus. The method includes: causing the money handling apparatus to store money in a first storage that stores and feeds money; causing the money handling apparatus to store money in a second storage that stores and feeds money; and causing the money handling apparatus to selectively perform a first collection process or a second collection process when performing a collection process of collecting money from the money handling apparatus.

The money handling apparatus may include the first storage, the second storage, and a controller, and the controller may execute the above method by outputting a control signal to the first storage and the second storage. The money handling apparatus may include an outlet and a transport unit that connects the first storage, the second storage, and the outlet. The controller may output a control signal to the first storage, the second storage, the outlet, and the transport unit.

The first collection process is a process in which the money handling apparatus dispenses, to the outlet, money fed from the first storage and money fed from the second storage, and the second collection process is a process in which the money handling apparatus consolidates money in the money handling apparatus into the first storage by moving money from the second storage to the first storage.

The first storage unit may be configured to shift to an open state in which an operator can access, from outside the money handling apparatus, money stored in the first storage. The first storage unit may also be configured to shift to a closed state in which the operator cannot access, from outside the money handling apparatus, money stored in the first storage. The second collection process may include a process of allowing the first storage to be shifted from the closed state to the open state after the money inside the money handling apparatus has been consolidated into the first storage.

The open state may be a state in which the operator can remove coins from the first storage unit. The open state may also be a state in which the first storage has been removed from the money handling apparatus. The first storage may have an opening, and the open state may be a state in which the opening of the first storage unit is exposed to the outside of the money handling apparatus.

Both the first storage and the second storage store and feed money. The first storage and the second storage are not, for example, storages exclusively for collecting money.

The money handling apparatus selectively performs the first collection process or the second collection process when performing the collection process of collecting money from the money handling apparatus.

In the first collection process, the money handling apparatus dispenses money stored therein to the outside of the money handling apparatus. The operator can collect the money. The money handling apparatus sequentially sends money to the outlet. Therefore, as the number of pieces of money to be collected increases, the time required for the first collection process increases.

In the second collection process, the operator can collect money from the money handling apparatus by directly taking money out of the first storage into which the money has been consolidated. Even if the number of pieces of money to be collected increases, the time required for the second collection process does not become longer.

Since the money handling apparatus can selectively perform the second collection process, the time required for the collection process can be reduced.

In the second collection process, after the money handling apparatus moves money from the second storage to the first storage, the money handling apparatus may notify completion of the second collection process. The notification may be a notification that allows the first storage to be set to the open state. The notification may be an instruction to the operator to remove the first storage.

By removing the first storage from the money handling apparatus, the operator can collect a large amount of money at one time. The second collection process can reduce the time required for the collection process. After emptying the first storage removed from the money handling apparatus, the operator reattaches the empty first storage into the money handling apparatus.

The money handling apparatus may perform a dispensing process of dispensing a specified amount of money to the outlet. The dispensing process is different from the collection process. The money handling apparatus may store, in advance in the second storage, money fed from the first storage as money to be dispensed from the outlet in the dispensing process. When the dispensing process starts, money stored in the second storage is fed, and the specified amount of money is dispensed to the outlet. The money handling apparatus may include a terminal including an input section. The operator may instruct execution of the collection process or the dispensing process using the terminal. The operator may specify an amount to be dispensed using the terminal.

The money handling apparatus may be, for example, a coin handling apparatus. The money handling apparatus may be, for example, an apparatus used for payment processing in a store. In payment processing, the money handling apparatus may perform a depositing process of depositing money paid by a customer to the store and may perform a dispensing process of dispensing change. The amount of money stored in the second storage may be a maximum amount of change dispensed in one payment processing operation.

The second storage may store money to be dispensed to the outlet as change. The second storage may store, for example, money corresponding to a minimum required set of pieces of money for change. In this case, the number of pieces of money stored in the second storage is relatively small. The second storage can quickly feed change, and the money handling apparatus can quickly dispense change to the outlet. In the second collection process, the time required to move money from the second storage to the first storage is reduced.

The money handling apparatus may store, in the first storage, money inserted into an inlet of the money handling apparatus.

The first storage may be a so-called recycle storage. The recycle storage is a storage that stores money inserted into the money handling apparatus in a depositing process and feeds money to be dispensed from the money handling apparatus in the depositing process.

The first storage may have a larger capacity than the second storage.

The first storage may store, for example, mixed denominations of money.

The money handling apparatus may output a counting result obtained by a recognition unit in the first collection process.

In the first collection process, the money handling apparatus can accurately manage money to be collected. Money collected from the money handling apparatus by the second collection process may be counted by means different from the money handling apparatus.

In the second collection process, after money is removed from the first storage, the money handling apparatus checks whether the first storage is empty by driving a feeding mechanism of the first storage in a money feeding direction and driving the recognition unit for a predetermined period of time.

As described above, in the second collection process, the operator directly removes money from the first storage. After the operator removes money from the first storage, the money handling apparatus drives the feeding mechanism of the first storage for the predetermined period of time. In a case where no money is recognized while the feeding mechanism is driven for the predetermined period of time, the money handling apparatus determines that the first storage is empty. If there is uncollected money, the money is fed from the first storage. For example, a money detection sensor or the recognition unit detects money, so that the money handling apparatus can detect the uncollected money. The money handling apparatus can reduce the possibility of uncollected money in the second collection process.

The money handling apparatus may drive the feeding mechanism of the first storage in a direction opposite to the money feeding direction before instructing an operation of removing the first storage in the second collection process.

Uncollected money described above tends to occur, for example, when money remains along the feeding mechanism of the first storage.

By driving the feeding mechanism of the first storage in the direction opposite to the money feeding direction, money remaining along the feeding mechanism is also returned to the storage area of the first storage. This configuration reduces the possibility that the operator will leave money uncollected after the first storage is opened.

The feeding mechanism of the first storage may include an endless belt and a plurality of pulleys that moves the belt. When the belt moves in the feeding direction, money engaged with the belt is fed from the first storage. When the belt moves in the direction opposite to the feeding direction, money engaged with the belt is returned to the first storage.

Before starting the second collection process, the money handling apparatus may confirm, based on the inventory amount in the first storage and the inventory amount in the second storage, that the first storage will not exceed its full capacity when money is moved from the second storage to the first storage.

In the second collection process, in a case where the first storage will exceed its full capacity when money is moved from the second storage to the first storage, money cannot be moved from the second storage to the first storage. The money handling apparatus confirms that the first storage will not exceed its full capacity based on the inventory amount in the first storage and the inventory amount in the second storage. Accordingly, the possibility of the first storage exceeding its full capacity can be reduced.

In a case where the first storage will exceed its full capacity when money is moved from the second storage to the first storage, the money handling apparatus may stop the second collection process.

The money handling apparatus may perform the first collection process in a case where either or both of a denomination and the number of pieces of money to be collected from the money handling apparatus are specified.

In the second collection process, money is directly removed from the first storage, the money handling apparatus cannot manage the denomination and the number of pieces of money to be collected. In a case where the operator specifies either or both of the denomination and the number of pieces of money to be collected from the money handling apparatus, the money handling apparatus performs the first collection process.

The money handling apparatus may perform the second collection process in a case where collection of all money in the money handling apparatus is specified.

The second collection process can reduce the time required for the collection process. Money collected by the second collection process may be counted by means different from the money handling apparatus. By that counting, money collected from the money handling apparatus by the second collection process can be accurately managed.

Based on a collection amount of money that is an amount of money to be collected from the money handling apparatus, the money handling apparatus may perform the first collection process in a case where the collection amount is less than a predetermined amount, and performs the second collection process in a case where the collection amount is greater than or equal to the predetermined amount.

Even in a case where collection of all money in the money handling apparatus is specified, the first collection process may be performed when the inventory amount in the money handling apparatus is less than a predetermined value and the collection amount is less than the predetermined amount.

The money handling apparatus may store selection information indicating selection of the first collection process or the second collection process set in advance, and when execution of the collection process is instructed, the money handling apparatus may perform the first collection process or the second collection process in accordance with the selection made in advance.

The operator may preset the first collection process or the second collection process, instead of selecting the first collection process or the second collection process each time the collection process is performed.

When execution of the collection process is instructed, the money handling apparatus may cause an operator to select the first collection process or the second collection process, and the money handling apparatus may perform the first collection process or the second collection process in accordance with selection made by the operator.

Alternatively, the operator may select the first collection process or the second collection process each time the collection process is performed.

In a case where the first collection process is selected, the money handling apparatus may allow either or both of a denomination and the number of pieces of money to be collected to be specified.

In a case where the second collection process is selected, all money may be collected from the money handling apparatus.

In a case where the first collection process is selected, the money handling apparatus may cause the operator to select whether to collect all money from the money handling apparatus or to collect coins of the specified denomination and/or the specified number of coins.

In a case where the second collection process is selected, the money handling apparatus may automatically collect all money from the money handling apparatus.

The technology disclosed herein also relates to a money handling apparatus. The money handling apparatus includes: a first storage that stores and feeds money; a second storage that stores and feeds money; an outlet to which money fed from the first storage or the second storage is dispensed; a transport unit that includes a transport path connecting the first storage, the second storage, and the outlet to each other, and that transports money among the first storage, the second storage, and the outlet; and a controller that outputs a control signal to the first storage, the second storage, and the transport unit. The controller selectively performs a first collection process or a second collection process when performing a collection process of collecting money from the first storage and the second storage. The first collection process is a process of dispensing, to the outlet, money fed from the first storage and money fed from the second storage. The second collection process is a process of consolidating money in the money handling apparatus into the first storage by moving money from the second storage to the first storage.

Since the controller of the money handling apparatus can selectively perform the second collection process, the money handling apparatus can reduce the time required for the collection process.

The money handling apparatus may further include a recognition unit that is located on the transport path and recognizes money fed from the first storage or the second storage. In the first collection process, the recognition unit may recognize money fed from the first storage and also recognize money fed from the second storage. The controller may output a counting result obtained by the recognition unit in the first collection process.

The first storage may include a feeding mechanism that feeds money. Before an operation of removing the first storage in the second collection process is instructed, the feeding mechanism may be driven in a direction opposite to the money feeding direction.

The first storage may include a feeding mechanism that feeds money. After money is removed from the first storage in the second collection process, the controller may check whether the first storage is empty by driving the feeding mechanism in a money feeding direction and driving the recognition unit for a predetermined period of time.

Before starting the second collection process, the controller may confirm, based on the inventory amount in the first storage and the inventory amount in the second storage, that the first storage will not exceed its full capacity when money is moved from the second storage to the first storage.

The second storage may store money fed from the first storage as money to be dispensed from the outlet in a dispensing process.

Hereinafter, embodiments of the money handling apparatus and the method for controlling the money handling apparatus will be described with reference to the drawings. The money handling apparatus and the method for controlling the money handling apparatus described herein are merely examples.

### Overall Structure of Money Handling Apparatus

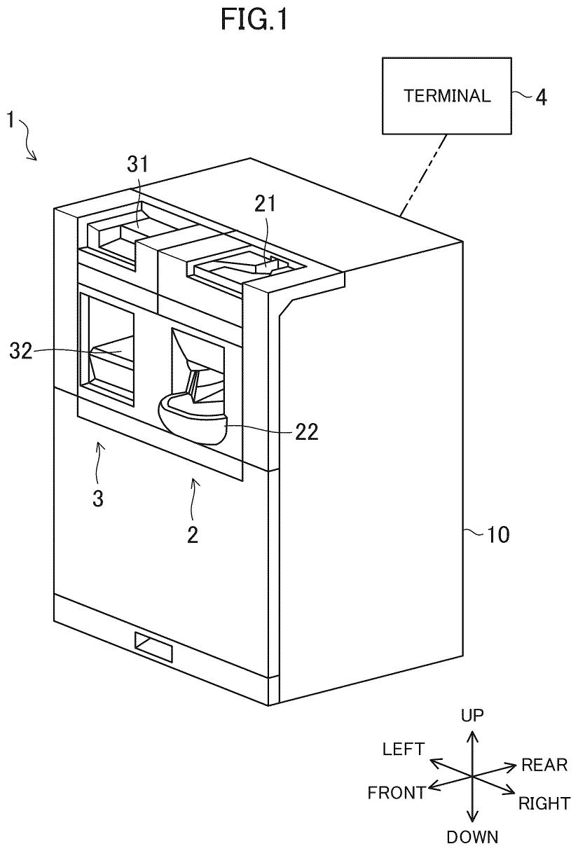

FIG. 1 shows an external appearance of a money handling apparatus 1. The money handling apparatus 1 includes a coin handling unit 2. The coin handling unit 2 handles coins.

The money handling apparatus 1 includes a banknote handling unit 3. The banknote handling unit 3 handles banknotes. The money handling apparatus 1 is not limited to including both the coin handling unit 2 and the banknote handling unit 3.

The coin handling unit 2 and the banknote handling unit 3 are arranged side by side in the left-right direction. The coin handling unit 2 and the banknote handling unit 3 are housed inside a housing 10 described below.

The left of the money handling apparatus 1 corresponds to the back left in FIG. 1, and the right of the money handling apparatus 1 corresponds to the front right in FIG. 1. That is, when an operator faces the front of the money handling apparatus 1, the operator's left corresponds to the left of the money handling apparatus 1, and the operator's right corresponds to the right of the money handling apparatus 1.

The front of the money handling apparatus 1 corresponds to the front left in FIG. 1, and the rear of the money handling apparatus 1 corresponds to the rear right in FIG. 1. The front of the money handling apparatus 1 is the side on which inlets 21, 31 or outlets 22, 32 of the coin handling unit 2 or the banknote handling unit 3 described below are located, and the rear of the money handling apparatus 1 is the opposite side.

The upper side of the money handling apparatus 1 corresponds to the upper side in FIG. 1, and the lower side of the money handling apparatus 1 corresponds to the lower side in FIG. 1. The upper and lower sides of the money handling apparatus 1 correspond, for example, to the upper and lower sides of the money handling apparatus 1 when installed on a floor surface.

The terms “left,” “right,” “front,” “rear,” “upper,” and “lower” are herein used merely to describe the money handling apparatus 1, the coin handling unit 2, or the banknote handling unit 3, and are not intended to limit the structures of the money handling apparatus 1, the coin handling unit 2, or the banknote handling unit 3.

The money handling apparatus 1 is installed, for example, in a store and is used for settlement of transactions between the store and customers. A user of the money handling apparatus 1 is a customer of the store. Store staff may operate the money handling apparatus 1 for management of the money handling apparatus 1. A person in charge of cash-in-transit (CIT) who collects banknotes and/or coins from the money handling apparatus 1 may also operate the money handling apparatus 1.

The money handling apparatus 1 performs at least payment processing in which a customer pays for services provided by the store. In the payment processing, an amount to be paid by the customer to the store is determined, for example, using a terminal 4. The terminal 4 may have, for example, a function as a cash register of the store. The money handling apparatus 1 and the terminal 4 are connected by wire or wirelessly. The terminal 4 has a display function and/or an operation input function.

In the payment processing, the coin handling unit 2 performs a coin depositing process and/or a coin dispensing process. The coin depositing process is a process of storing coins inserted by the customer inside the coin handling unit 2. The coin dispensing process is a process of dispensing coins as change from the coin handling unit 2.

Like the coin handling unit 2, the banknote handling unit 3 also performs a banknote depositing process and/or a banknote dispensing process in the payment processing. The banknote depositing process is a process of storing banknotes inserted by the customer inside the banknote handling unit 3. The banknote dispensing process is a process of dispensing banknotes as change from the banknote handling unit 3.

### Structure of Coin Handling Unit

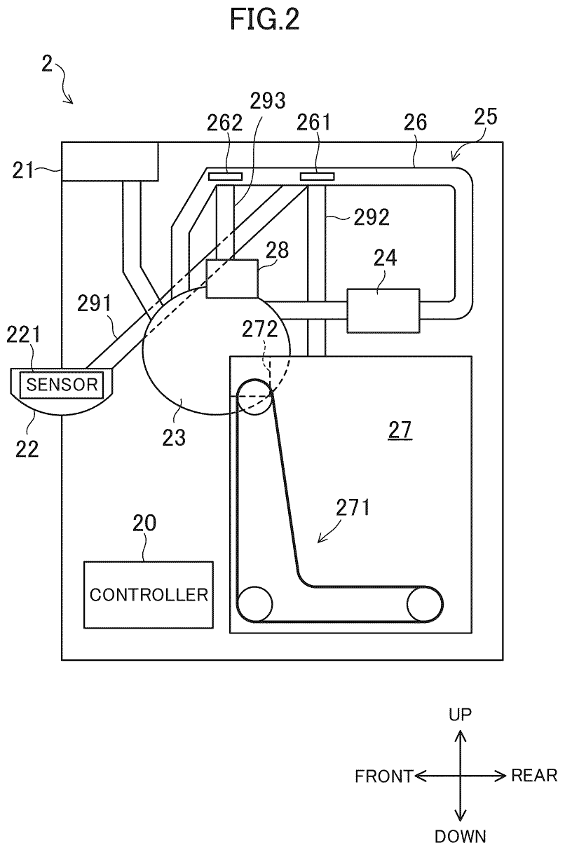

FIG. 2 shows an internal structure of the coin handling unit 2.

The coin handling unit 2 includes a coin inlet 21. The coin inlet 21 has a function to hold one or more coins inserted by a customer and send the coins held therein to a feeding unit 23 described later.

The coin handling unit 2 includes a coin outlet 22. The coin outlet 22 holds one or more coins to be dispensed to a customer. The customer manually removes the coins from the coin outlet 22.

The coin outlet 22 is used not only to dispense change but also to collect coins from the coin handling unit 2. The coin handling unit 2 may dispense coins to the coin outlet 22 for collection.

The coin outlet 22 includes a sensor 221. The sensor 221 is attached to the coin outlet 22. The sensor 221 detects that the coin outlet 22 has become full of coins. The sensor 221 outputs a detection signal to a controller 20. Upon receiving the detection signal from the sensor 221, the controller 20 stops dispensing coins to the coin outlet 22.

The coin handling unit 2 includes the feeding unit 23. The feeding unit 23 is located inside the coin handling unit 2. The feeding unit 23 has a function to temporarily store coins and feed the stored coins one by one. The feeding unit 23 may be, for example, a rotary disk-type feeding unit 23 having a rotary disk. The feeding unit 23 is connected to the coin inlet 21. The feeding unit 23 is also connected to a transport unit 25. The feeding unit 23 feeds coins sent from the coin inlet 21 one by one to the transport unit 25 to transport the coins to a recognition unit 24.

The coin handling unit 2 includes the recognition unit 24 on a transport path 26 of the transport unit 25. Coins fed from the feeding unit 23 are transported by the transport unit 25 and pass through the recognition unit 24. The recognition unit 24 recognizes the denomination of coins passing therethrough. The recognition unit 24 may also recognize authenticity and fitness of coins. The recognition unit 24 includes either or both of an optical sensor (such as a line sensor or a camera) and a magnetic sensor.

The coin handling unit 2 includes the transport unit 25. The transport unit 25 transports coins inside the coin handling unit 2. The transport unit 25 includes the transport path 26. Coins are transported along the transport path 26. The transport path 26 is connected to the feeding unit 23 so as to form a loop from the feeding unit 23 through the recognition unit 24 back to the feeding unit 23. Coins fed from the feeding unit 23 can thus return to the feeding unit 23 after passing through the recognition unit 24.

The transport unit 25 includes a first gate 261. The first gate 261 is provided in the transport path 26. The first gate 261 is a gate that selectively sends coins that have passed through the recognition unit 24 to the coin outlet 22, a first storage 27, or a second gate 262. A first chute 291 connects the first gate 261 and the coin outlet 22. A second chute 292 connects the first gate 261 and the first storage 27.

The transport unit 25 includes the second gate 262. The second gate 262 is provided downstream of the first gate 261 in the coin transport direction in the transport path 26.

The second gate 262 is a gate that selectively sends coins that have passed through the recognition unit 24 to a second storage 28 or the feeding unit 23. A third chute 293 connects the second gate 262 and the second storage 28.

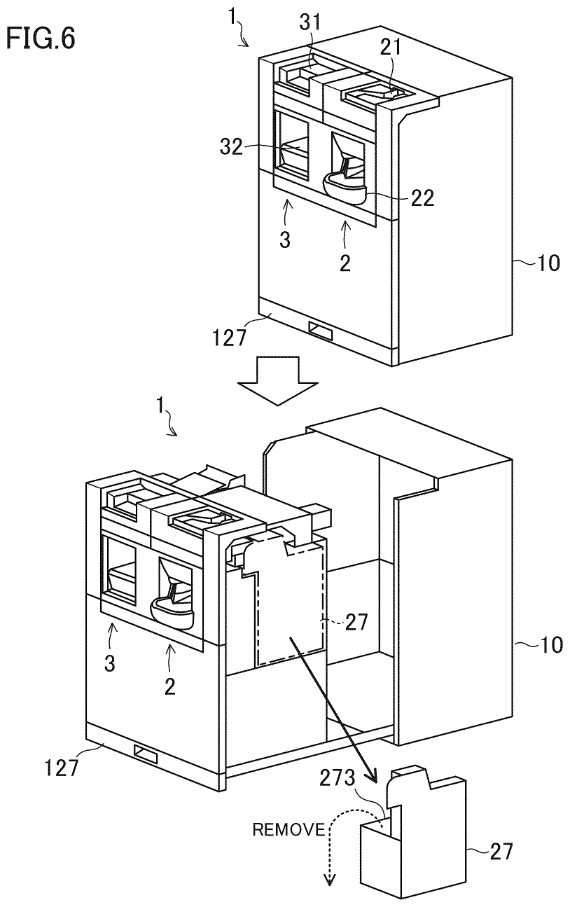

The coin handling unit 2 includes the first storage 27. The first storage 27 is installed inside the coin handling unit 2. The first storage 27 is removable from the coin handling unit 2. The first storage 27 stores coins. The first storage 27 stores mixed denominations of coins. As used herein, “mixed” means that stored coins are not separated by denomination. The first storage 27 has an opening 273 open upward (see FIG. 6).

The first storage 27 has a larger capacity than the second storage 28. The first storage 27 is located below the first gate 261. Coins fall from the transport path 26 into the first storage 27 through the second chute 292 and are stored in the first storage 27. The second chute 292 may be arranged so as to extend into the first storage 27 through the opening 273. The second chute 292 may be arranged such that coins falling from a lower end of the second chute 292 fall into the first storage 27 through the opening 273.

The first storage 27 includes a feeding mechanism 271 that feeds coins stored therein to the feeding unit 23. The feeding mechanism 271 includes an endless belt and a plurality of pulleys that moves the belt. When the belt moves in the feeding direction, coins engaged with the belt are sent to the feeding unit 23 through an outlet 272 of the first storage 27.

The coin handling unit 2 includes the second storage 28. The second storage 28 is installed inside the coin handling unit 2. The second storage 28 stores coins. The second storage 28 stores mixed denominations of coins. The second storage 28 has a smaller capacity than the first storage 27.

The second storage 28 is located below the second gate 262. When the second gate 262 opens, coins fall from the transport path 26 into the second storage 28 through the third chute 293 and are stored in the second storage 28. The second storage 28 is located above the feeding unit 23 and connected to the feeding unit 23. The second storage 28 includes a shutter at its bottom. When the shutter is opened, the second storage 28 can cause all coins stored therein to fall and be delivered to the feeding unit 23.

The coin handling unit 2 includes the controller 20. The controller 20 controls functions and operations of parts of the coin handling unit 2 by outputting control signals to them. For example, a program corresponding to the controller 20 is stored in advance in a dedicated memory, and the functions and operations of the controller 20 are implemented by execution of the program using hardware such as a central processing unit (CPU). Through control of each part by the controller 20, various processes performed by the coin handling unit 2 are implemented.

In an exemplary embodiment, the controller 20 is one or more general-purpose processing circuits, such as a microprocessor, a microcontroller, or a digital signal processor, or a dedicated processing circuit such as an application-specific integrated circuit (ASIC).

The coin handling unit 2 does not include a dedicated collection cassette or a dedicated collection storage for collecting coins from the coin handling unit 2. The first storage 27 and the second storage 28 each has a function to supply coins to be dispensed to the coin outlet 22 in the coin dispensing process.

### Structure of Banknote Handling Unit

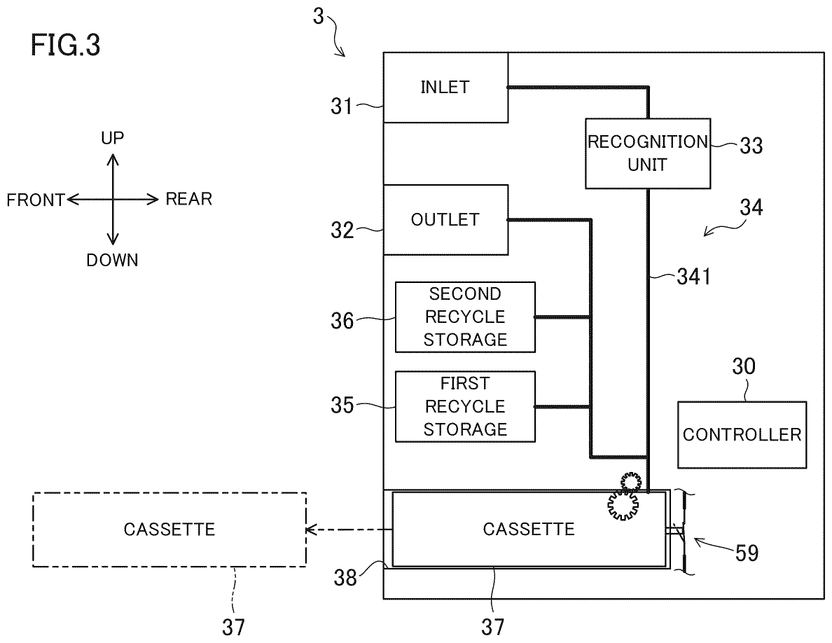

FIG. 3 shows an internal structure of the banknote handling unit 3.

The banknote handling unit 3 includes a banknote inlet 31. The banknote inlet 31 receives banknotes. The banknote inlet 31 has a function to hold one or more banknotes inserted by a customer and send the banknotes one by one into the banknote handling unit 3.

The banknote handling unit 3 includes a banknote outlet 32. The banknote outlet 32 dispenses banknotes from the banknote handling unit 3. The customer manually removes the banknotes from the banknote outlet 32.

The banknote handling unit 3 includes a recognition unit 33. The recognition unit 33 is connected to the banknote inlet 31 via a transport path 341. Banknotes transported by a transport unit 34 pass through the recognition unit 33 one by one. The recognition unit 33 recognizes denomination and authenticity of banknotes passing therethrough. The recognition unit 33 may further recognize fitness of banknotes. The recognition unit 33 includes an optical sensor (such as a line sensor or a camera) and a magnetic sensor.

The banknote handling unit 3 includes a first recycle storage 35. The first recycle storage 35 stores banknotes that have passed through the recognition unit 33. The first recycle storage 35 also feeds banknotes stored therein. The first recycle storage 35 may be, for example, a tape-type storage. A tape-type storage stores banknotes by winding banknotes together with a tape around a drum. The first recycle storage 35 may be a stack-type storage. A stack-type storage stores banknotes by stacking them.

The banknote handling unit 3 further includes a second recycle storage 36. Like the first recycle storage 35, the second recycle storage 36 stores banknotes that have passed through the recognition unit 33. The second recycle storage 36 also feeds banknotes stored therein. The second recycle storage 36 may be, for example, a tape-type storage or a stack-type storage.

Types of banknotes stored in the first recycle storage 35 and the second recycle storage 36 are predetermined, and the first recycle storage 35 and the second recycle storage 36 each store a single denomination predetermined for the respective storage. Based on the recognition result of the recognition unit 33, the transport unit 34 selectively transports banknotes that have passed through the recognition unit 33 to the first recycle storage 35 or the second recycle storage 36. The first recycle storage 35 and the second recycle storage 36 may each store mixed denominations of banknotes predetermined for the respective storage.

The banknote handling unit 3 includes a cassette 37. The cassette 37 stores banknotes not used for recycling. Banknotes not used for recycling include, for example, banknotes of denominations not stored in the first recycle storage 35 and the second recycle storage 36, or banknotes of denominations for which a preset number has already been stored in the first recycle storage 35 and the second recycle storage 36 and for which no further storage is required. Banknotes of denominations not stored in the first recycle storage 35 and the second recycle storage 36 include, for example, high-denomination banknotes that cannot be used as change.

The cassette 37 is also used when the banknote handling unit 3 performs a collection process of collecting banknotes stored in the first recycle storage 35 or the second recycle storage 36 in accordance with a collection instruction issued by store staff.

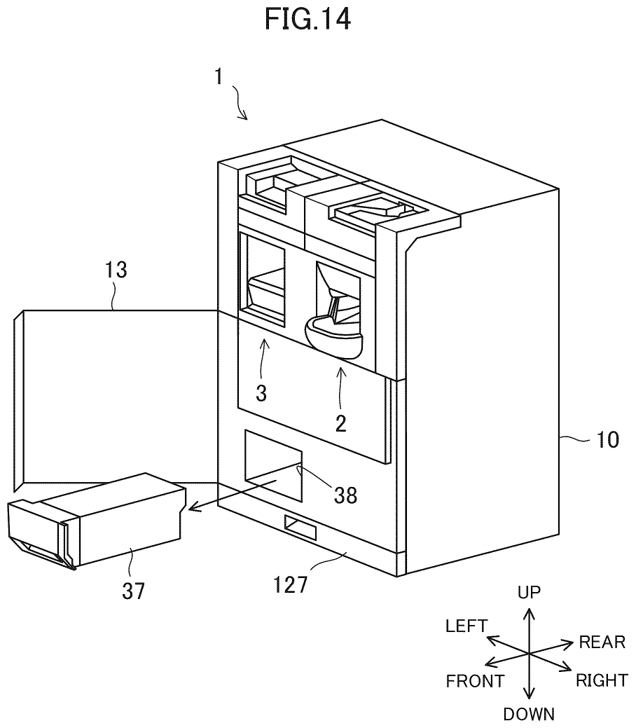

As shown in FIG. 3 or 14, the cassette 37 is detachably mounted in a mounting portion 38 of the banknote handling unit 3. When the cassette 37 storing banknotes to be collected is removed from the mounting portion 38, collection of the banknotes is completed. An empty cassette 37 is then mounted into the mounting portion 38.

The banknote handling unit 3 includes the transport unit 34. The transport unit 34 transports banknotes one by one along the transport path 341. The transport path 341 connects the banknote inlet 31, the banknote outlet 32, the recognition unit 33, the first recycle storage 35, the second recycle storage 36, and the cassette 37.

The transport unit 34 includes a transport member. The transport member is constituted by a combination of many rollers, a plurality of belts, a motor that drives the rollers and the belts, and a plurality of guides.

The banknote handling unit 3 includes a controller 30. The controller 30 controls functions and operations of parts of the banknote handling unit 3 by outputting control signals to them. For example, a program corresponding to the controller 30 is stored in advance in a dedicated memory, and the functions and operations of the controller 30 are implemented by execution of the program using hardware such as a central processing unit (CPU). Through control of each part by the controller 30, various processes performed by the banknote handling unit 3 are implemented.

In an exemplary embodiment, the controller 30 is one or more general-purpose processing circuits, such as a microprocessor, a microcontroller, or a digital signal processor, or a dedicated processing circuit such as an application-specific integrated circuit (ASIC).

### Processing of Coin Handling Unit

Next, the operation of the coin handling unit 2 during payment processing will be described. When the money handling apparatus 1 performs payment processing for a customer, the coin handling unit 2 may perform a coin depositing process and a coin dispensing process. The coin depositing process is a process in which the coin handling unit 2 stores coins inserted into the coin inlet 21 in the first storage 27. The coin dispensing process is a process in which the coin handling unit 2 dispenses coins to be paid out as change to the customer from the second storage 28 to the coin outlet 22.

The second storage 28 stores coins to be dispensed in the coin dispensing process. The second storage 28 stores in advance at least a minimum required set of coins for change. The minimum required set of coins for change is a combination of the minimum numbers of coins for each denomination that is necessary to be able to handle all amounts of change payable in coins. For example, in a case where the coin handling unit 2 handles euro coins, the minimum required set of coins for change includes two 2-euro coins, one 1-euro coin, one 0.50-euro coin, two 0.20-euro coins, one 0.10-euro coin, one 0.05-euro coin, two 0.02-euro coins, and one 0.01-euro coin. The coin handling unit 2 ensures that the second storage 28 stores coins for change at least before the money handling apparatus 1 starts payment processing. For this purpose, after the coin dispensing process, the coin handling unit 2 performs a replenishment process of replenishing the second storage 28 with coins to be used as change.

In the coin depositing process, the coin inlet 21 sends inserted coins to the feeding unit 23. The feeding unit 23 feeds coins one by one to the recognition unit 24. The recognition unit 24 recognizes denominations of coins. Coins that have passed through the recognition unit 24 reach the first gate 261. Based on the recognition result of the recognition unit 24, the first gate 261 sends coins that are acceptable by the coin handling unit 2 to the first storage 27. The first storage 27 stores mixed denominations of coins. Based on the recognition result of the recognition unit 24, the first gate 261 sends coins that are unacceptable by the coin handling unit 2 to the coin outlet 22. The unacceptable coins are returned to the customer.

Next, in the coin dispensing process, the second storage 28 sends all coins stored therein to the feeding unit 23. The feeding unit 23 feeds coins from the second storage 28 one by one to the recognition unit 24. The recognition unit 24 recognizes denominations of coins. Coins that have passed through the recognition unit 24 reach the first gate 261. Based on the recognition result of the recognition unit 24, the first gate 261 sends coins to be paid out as change to the coin outlet 22. The coin outlet 22 holds the change. Coins not to be paid out as change are transported along the transport path 26 to the second gate 262. The second gate 262 sends the coins to the second storage 28, and the second storage 28 stores the coins. When all change is dispensed to the coin outlet 22, the coin dispensing process is completed.

Since the second storage 28 feeds coins in the coin dispensing process, the coin handling unit 2 can complete the coin dispensing process quickly. This is because the second storage 28 stores fewer coins than the first storage 27, for example, the minimum required set of coins for change.

After the coin dispensing process, the coin handling unit 2 performs the replenishment process. In the replenishment process, the first storage 27 sends coins to the feeding unit 23. The feeding unit 23 feeds coins received from the first storage 27 one by one to the recognition unit 24. The recognition unit 24 recognizes denominations of coins. Coins that have passed through the recognition unit 24 reach the first gate 261. Based on the recognition result of the recognition unit 24, the first gate 261 sends coins not to be used to replenish the second storage 28 to the first storage 27.

Coins to be used to replenish the second storage 28 reach the second gate 262. The second gate 262 sends coins to be stored in the second storage 28 to the second storage 28. The minimum required set of coins for change is thus stored in the second storage 28.

### Collection Process of Coin Handling Unit

Next, the operation of the coin handling unit 2 during a collection process will be described with reference to the drawings. The coin handling unit 2 performs a collection process when an operator instructs execution of the collection process, for example, through the terminal 4. The coin handling unit 2 can selectively perform two types of collection processes: a first collection process and a second collection process. The first collection process and the second collection process will be described as an example in which coins are collected from both the first storage 27 and the second storage 28.

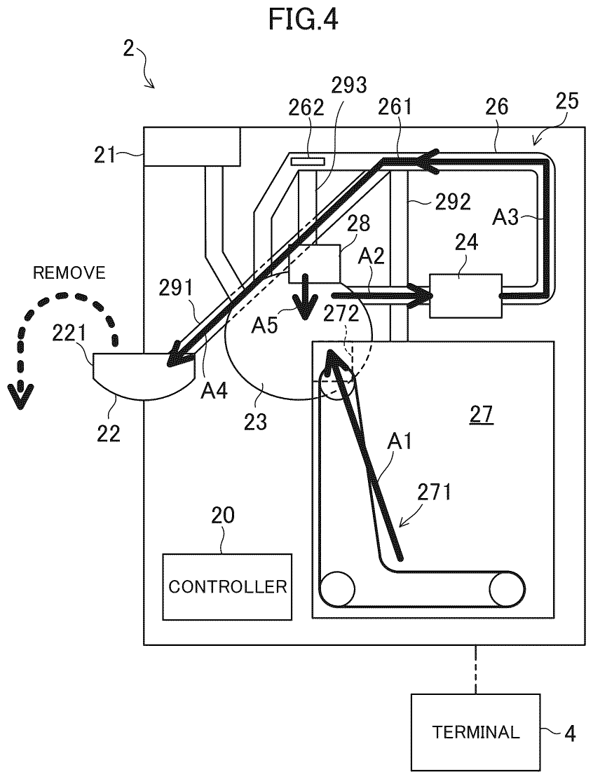

FIG. 4 shows an operation of the coin handling unit 2 during the first collection process. In the first collection process, the first storage 27 feeds coins stored therein to the feeding unit 23 as indicated by arrow A1. The feeding unit 23 feeds the coins one by one to the recognition unit 24 (see arrow A2). The recognition unit 24 recognizes the coins. The transport unit 25 transports the recognized coins to the first gate 261 (see arrow A3). The coins are sent from the first gate 261 to the coin outlet 22.

The second storage 28 also feeds coins stored therein to the feeding unit 23 (see arrow A5). The coins are then fed from the feeding unit 23, recognized by the recognition unit 24, and sent from the first gate 261 to the coin outlet 22 in the same manner as that described above (see arrows A2, A3, and A4).

In the first collection process, either the first storage 27 or the second storage 28 may first feed coins to the feeding unit 23.

The operator manually removes coins dispensed to the coin outlet 22 (see dashed arrow in FIG. 4). The operator is a person in charge of CIT or store staff. The number of coins that can be held in the coin outlet 22 is smaller than the number of coins that can be stored in the first storage 27. The operator removes coins dispensed to the coin outlet 22 as appropriate. When the sensor 221 detects that the coin outlet 22 has become full, the controller 20 stops dispensing coins. After the operator removes coins from the coin outlet 22, the controller 20 resumes dispensing coins.

In the first collection process, the recognition unit 24 recognizes and counts coins to be collected. Upon completion of the first collection process, information on coins to be collected, that is, the number of coins for each denomination, can be determined. In the first collection process, the controller 20 of the coin handling unit 2 outputs the counting result of the recognition unit 24 to, for example, the terminal 4.

Since the recognition unit 24 recognizes denominations of coins, it is also possible to collect only coins of denominations specified by the operator in the first collection process. Further, since the controller 20 counts the number of coins recognized by the recognition unit 24, it is also possible to collect the number of coins specified by the operator in the first collection process.

On the other hand, in the first collection process, the transport unit 25 transports coins one by one while the recognition unit 24 performs recognition. Therefore, as the number of coins to be collected increases, the time required for the collection process becomes longer. In the first collection process, since the operator needs to manually remove coins dispensed to the coin outlet 22 as appropriate, the amount of time the operator is required to remain engaged in the operation increases.

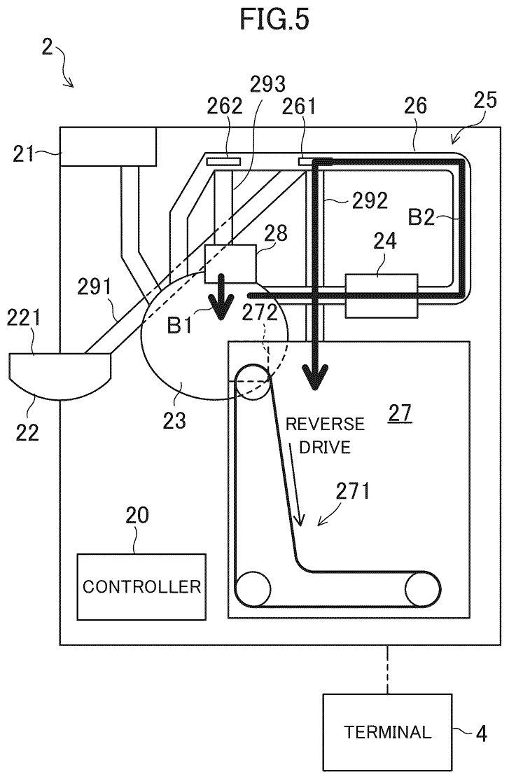

FIGS. 5 to 7 show the operation of the coin handling unit 2 related to the second collection process. In the second collection process, the second storage 28 feeds coins stored therein to the feeding unit 23 as indicated by arrow B1. The feeding unit 23 feeds coins one by one (see arrow B2). The coins thus fed from the feeding unit 23 are sent from the first gate 261 to the first storage 27.

In the second collection process, coins in the second storage 28 are stored in the first storage 27. Before the start of the second collection process, the coin handling unit 2 confirms, based on the inventory amount in the first storage 27 and the inventory amount in the second storage 28, that the first storage 27 will not exceed its full capacity when coins are moved from the second storage 28 to the first storage 27. This confirmation makes it possible to avoid the first storage 27 exceeding its full capacity when the second collection process is performed.

In a case where the coin handling unit 2 determines that the first storage 27 would exceed its full capacity, the coin handling unit 2 may not perform the second collection process.

When coins are moved from the second storage 28 to the first storage 27, the controller 20 of the coin handling unit 2 prompts the operator to set the first storage 27 from a closed state to an open state. The closed state is a state in which coins stored in the first storage 27 are not externally accessible. The open state is a state in which coins stored in the first storage 27 are externally accessible, and in particular, a state in which the operator can manually remove coins from the first storage 27. The open state is, for example, a state in which the first storage 27 is removed from the coin handling unit 2. The controller 20 may notify, for example, through the terminal 4, that movement of coins from the second storage 28 to the first storage 27 is completed. The controller 20 may also instruct, for example, through the terminal 4, the operator to set the first storage 27 to the open state.

As shown in FIG. 6, the coin handling unit 2 and the banknote handling unit 3 can be pulled forward from the housing 10. In the second collection process, after the operator pulls the coin handling unit 2 and the banknote handling unit 3 forward from the housing 10, the operator removes the first storage 27, which is mounted on the right side of the coin handling unit 2, from the coin handling unit 2 (see the solid arrow in the lower part of FIG. 6). When the coin handling unit 2 is pulled forward from the housing 10, the opening 273 of the first storage 27 is exposed to the outside. The operator can collect coins from the coin handling unit 2 by directly removing the coins from the removed first storage 27 through the opening 273 (see the dashed arrow in the lower part of FIG. 6).

The operator may set the first storage 27 to the open state without completely removing the first storage 27 from the coin handling unit 2. For example, the operator may set the first storage 27 to the open state by merely pulling the first storage 27 out from the coin handling unit 2 to such an extent that at least part of the opening 273 is exposed to the outside.

The first storage 27 includes the feeding mechanism 271, and for example, coins may remain along the belt. In the second collection process, there is a possibility that coins may be left uncollected from the removed first storage 27.

Accordingly, before the first storage 27 is removed from the coin handling unit 2, that is, when execution of the second collection process is instructed, the feeding mechanism 271 of the first storage 27 is driven in a reverse direction, namely a direction opposite to the coin feeding direction (see FIG. 5). When the feeding mechanism 271 is driven in the reverse direction, coins remaining along the belt are returned to the storage area of the first storage 27. As a result, the possibility of uncollected coins from the removed first storage 27 is reduced.

After collecting coins from the removed first storage 27, the operator reattaches the first storage 27 to the coin handling unit 2. After reattachment of the first storage 27, the operator returns the coin handling unit 2 and the banknote handling unit 3 into the housing 10.

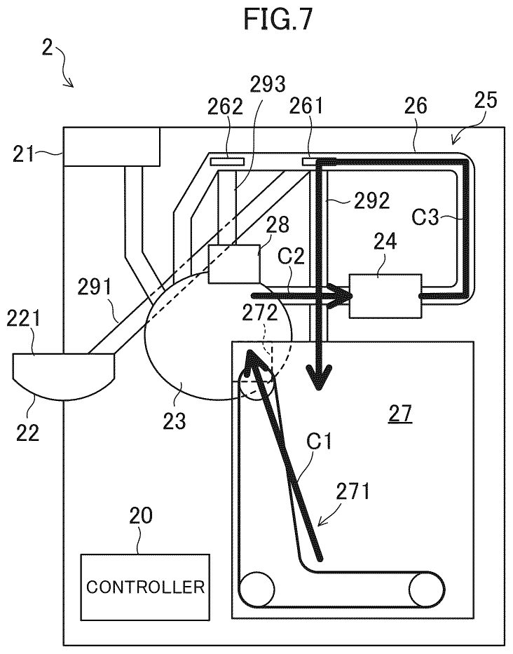

Thereafter, the coin handling unit 2 checks whether the first storage 27 is empty (that is, performs post-processing). Specifically, as shown in FIG. 7, the first storage 27 drives the feeding mechanism 271 in the feeding direction (see arrow C1 in FIG. 7). The feeding unit 23 performs a coin feeding operation (see arrow C2). In a case where coins remain in the first storage 27, the remaining coins are sent from the first storage 27 to the feeding unit 23 and further sent from the feeding unit 23 to the recognition unit 24. By the recognition unit 24 recognizing the remaining coins, the coin handling unit 2 can detect the presence of remaining coins.

Coins that have passed through the recognition unit 24 are returned to the first storage 27 via the first gate 261, as indicated by arrow C3.

In a case where the recognition unit 24 does not recognize any coins even though the first storage 27 continues driving the feeding mechanism 271 for a predetermined period of time, the coin handling unit 2 determines that there are no remaining coins in the first storage 27.

Instead of the recognition unit 24 detecting the presence or absence of remaining coins, a coin passage sensor provided in the transport path 26 may detect the presence or absence of remaining coins.

In the second collection process, the transport unit 25 does not transport coins, or even in a case where the transport unit 25 transports coins, it transports only a small number of coins from the second storage 28. The time required for the second collection process is shorter than that for the first collection process. In the second collection process, the amount of time the operator is required to remain engaged in the operation is short. The second collection process is particularly effective, for example, when collecting all coins stored in the coin handling unit 2.

The fact that the transport unit 25 does not transport coins or transports very few coins during the collection process reduces power consumption during the collection process, and also shortens the driving time and reduces the driving frequency of the coin handling unit 2. As a result, the service life of the coin handling unit 2 can be extended.

On the other hand, unlike in the first collection process, neither recognition nor counting of collected coins is performed in the second collection process. Therefore, the operator needs to separately count the collected coins.

In addition, in the second collection process, since the operator directly collects coins from the first storage 27, there is a possibility that an operational error may occur. For example, coins may be left uncollected from the first storage 27.

Furthermore, in the second collection process, the coin handling unit 2 performs post-processing after an empty first storage 27 is reattached. Therefore, for example, in a case where the number of collected coins is small, the first collection process, in which post-processing is not performed, may reduce the required time compared to the second collection process.

### Selection of Collection Process

As described above, the coin handling unit 2 can selectively perform two types of collection processes: the first collection process and the second collection process.

The operator may select either the first collection process or the second collection process when instructing the coin handling unit 2 to perform the collection process. The operator can select the first collection process or the second collection process as desired.

An administrator of the money handling apparatus 1 may set, in advance, the collection process of the coin handling unit 2 to the first collection process or the second collection process. The money handling apparatus 1 stores the selection information set in advance. When execution of the collection process is instructed, the coin handling unit 2 performs the first collection process or the second collection process in accordance with the preset selection. By such advance setting, an operator who instructs execution of the collection process can omit selecting the first collection process or the second collection process, which improves operator convenience.

The coin handling unit 2 may perform either the first collection process or the second collection process depending on the amount of coins to be collected from the coin handling unit 2 (hereinafter referred to as “collection amount”). That is, the coin handling unit 2 may perform the first collection process in a case where the collection amount is less than a predetermined amount, and may perform the second collection process in a case where the collection amount is greater than or equal to the predetermined amount.

That is, in a case where the collection amount is relatively small, the coin handling unit 2 performs the first collection process. Since the collection amount is relatively small, the time required for the first collection process is relatively short. By performing the first collection process, the coin handling unit 2 can perform the collection process accurately and strictly. In the case where the collection amount is small, it may not be necessary to set the first storage to the open state. Therefore, the time required for the first collection process may become shorter than the time required for the second collection process. The collection amount is a collection amount specified by the operator. Even in a case where collection of all coins in the coin handling unit 2 is specified, the first collection process may be performed in a case where the inventory amount in the coin handling unit 2 is less than a predetermined value and the collection amount is therefore less than the predetermined amount.

In a case where the collection amount is relatively large, the coin handling unit 2 performs the second collection process. Since the collection amount is relatively large, the time required for the first collection process is long. In the case where the collection amount is relatively large, the time required for the second collection process is shorter than that required for the first collection process.

In a case where collection of all coins stored in the coin handling unit 2 is specified, the collection amount corresponds to the total inventory amount in the first storage 27 and the second storage 28 of the coin handling unit 2. In a case where collection of all coins in the coin handling unit 2 is specified by the operator, the coin handling unit 2 may perform either the first collection process or the second collection process depending on the inventory amount in the coin handling unit 2. That is, the coin handling unit 2 may perform the first collection process in a case where the inventory amount in the coin handling unit 2 is less than a predetermined value, and may perform the second collection process in a case where the inventory amount in the coin handling unit 2 is greater than or equal to the predetermined value.

In a case where collection of all coins in the coin handling unit 2 is specified, the coin handling unit 2 may perform the second collection process.

This is because, in the case where collection of all coins is specified, it is expected that the number of coins to be collected is large. In a case where the number of coins to be collected is large, the second collection process can reduce the time required for the collection process.

In a case where either or both of the denomination and the number of coins to be collected from the coin handling unit 2 is specified, the coin handling unit 2 may perform the first collection process.

In the second collection process, since coins are directly removed from the first storage 27, the coin handling unit 2 is unable to manage the denominations and the numbers of coins to be collected. In a case where either or both of the denomination and the number of coins to be collected from the coin handling unit 2 is specified by the operator, the coin handling unit 2 performs the first collection process. Since the recognition unit 24 recognizes the coins to be collected, the coin handling unit 2 can accurately collect coins of the specified denomination and/or the specified number of coins.

In a case where the first collection process is selected by the operator, the coin handling unit 2 may perform a process of collecting all coins from the coin handling unit 2 or collecting coins of the specified denomination and/or the specified number of coins from the coin handling unit 2.

On the other hand, in a case where the second collection process is selected by the operator, the coin handling unit 2 may perform a process of collecting all coins from the coin handling unit 2.

As described above, the first collection process is a process capable of counting coins to be collected. The first collection process can collect all coins from the coin handling unit 2, or can collect coins of the specified denomination and/or the specified number of coins. In a case where the first collection process is selected, the coin handling unit 2 may further cause the operator to select whether to collect all coins from the coin handling unit 2 or to collect coins of the specified denomination and/or the specified number of coins. In the case where the first collection process is selected by the operator, the coin handling unit 2 may display information that allows the operator to specify the denomination and/or the number of coins to be collected or to specify the amount of money for the coins to be collected.

The second collection process cannot count coins to be collected. In a case where the second collection process is selected, the coin handling unit 2 may automatically collect all coins from the coin handling unit 2.

### Housing of Money Handling Apparatus

As described above, the money handling apparatus 1 is installed in a store. The money handling apparatus 1 is configured such that its overall height can be easily set in accordance with usage conditions in the store. For example, in a store where customers use the money handling apparatus 1 while seated, the overall height is set to be low, whereas in a store where customers use the money handling apparatus 1 while standing, the overall height is set to be high. Optimizing the overall height of the money handling apparatus 1 improves operability of the money handling apparatus 1.

The height difference between the installation surface of the money handling apparatus 1 and the floor surface on which customers stand varies from store to store, and therefore it is desirable that the overall height of the money handling apparatus 1 can be finely adjusted. For example, in a case where the money handling apparatus 1 is installed under store fixtures such as a counter, the height of the money handling apparatus 1 can be adjusted in accordance with the height of the counter.

As described above, the money handling apparatus 1 is configured such that the coin handling unit 2 and the banknote handling unit 3 are housed in the housing 10. The money handling apparatus 1 disclosed herein has a structure that allows the overall height to be easily adjusted. Hereinafter, the structure of the money handling apparatus 1 will be described with reference to the drawings.

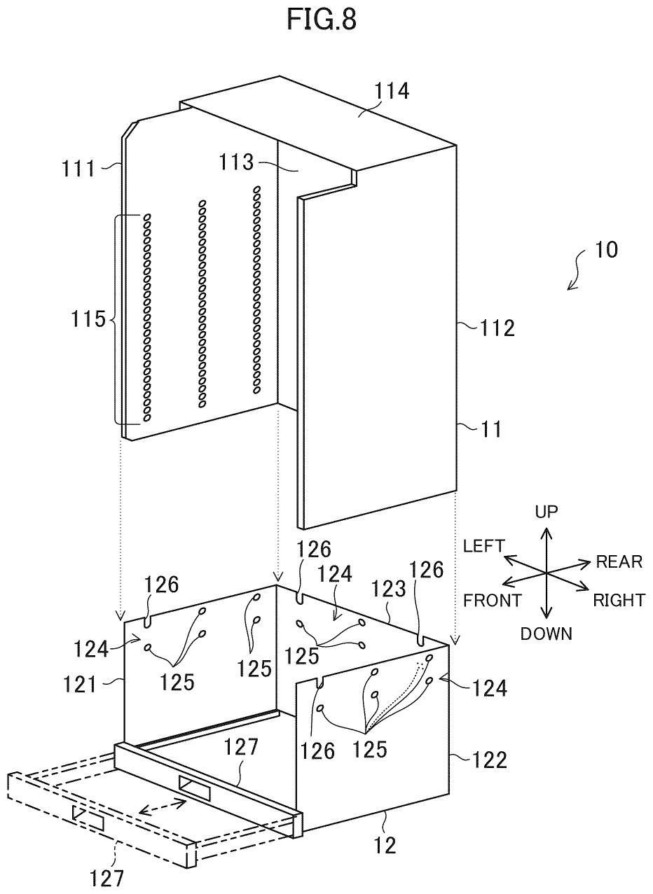

FIG. 8 shows the housing 10 of the money handling apparatus 1. The housing 10 includes an upper housing 11 and a lower housing 12. FIG. 8 is an exploded view showing the upper housing 11 and the lower housing 12 separated from each other. The upper housing 11 is positioned above the lower housing 12, and the upper housing 11 and the lower housing 12 are coupled to each other.

The lower housing 12 includes a left side wall 121, a right side wall 122, and a rear wall 123. The left side wall 121, the right side wall 122, and the rear wall 123 are flat plates that extend upward from a bottom portion of the lower housing 12. The left side wall 121, the right side wall 122, and the rear wall 123 are connected to each other and form a U-shape as viewed in plan.

The left side wall 121, the right side wall 122, and the rear wall 123 each include a coupling portion 124. The coupling portion 124 is a portion for coupling the lower housing 12 and the upper housing 11. The coupling portion 124 is located at an upper end portion of each of the left side wall 121, the right side wall 122, and the rear wall 123. The coupling portion 124 includes through holes 125 and notches 126.

Each through hole 125 extends through a corresponding one of the left side wall 121, the right side wall 122, and the rear wall 123 in a thickness direction. The through holes 125 are arranged in each of the left side wall 121, the right side wall 122, and the rear wall 123 at intervals in a horizontal direction and an up-down direction.

Each notch 126 extends downward from the upper edge of a corresponding one of the left side wall 121, the right side wall 122, and the rear wall 123. The left side wall 121 and the right side wall 122 each have one notch 126 near its front end. The rear wall 123 has a total of two notches 126, one near its left end and one near its right end. The notches 126 are used not only for coupling the upper housing 11 and the lower housing 12 but also for positioning the upper housing 11 and the lower housing 12 during an operation of coupling the upper housing 11 and the lower housing 12. The positioning is performed using screws 128 temporarily fastened to the upper housing 11.

The lower housing 12 further includes a slider 127. The slider 127 is positioned at the bottom portion of the lower housing 12 and includes slide rails extending in a front-rear direction. As shown in phantom in FIG. 8, the slider 127 is movable in the front-rear direction. The coin handling unit 2 and the banknote handling unit 3 are placed on the slider 127. When the slider 127 is moved forward, the coin handling unit 2 and the banknote handling unit 3 are pulled forward from the housing 10, as shown in the lower part of FIG. 6. When the slider 127 is moved rearward, the coin handling unit 2 and the banknote handling unit 3 are housed inside the housing 10, as shown in the upper part of FIG. 6.

The upper housing 11 includes a left side wall 111, a right side wall 112, a rear wall 113, and a top plate 114. The left side wall 111, the right side wall 112, and the rear wall 113 are flat plates extending downward from the top plate 114. The top plate 114 is a flat plate having a flat upper surface.

The left side wall 111, the right side wall 112, and the rear wall 113 are adjacent to the left side wall 121, the right side wall 122, and the rear wall 123 of the lower housing 12 and are coupled to the left side wall 121, the right side wall 122, and the rear wall 123, respectively.

Each of the left side wall 111, the right side wall 112, and the rear wall 113 includes a plurality of screw holes 115. The screw holes 115 open on the inner surface of each of the left side wall 111, the right side wall 112, and the rear wall 113. The screw holes 115 are arranged at equal intervals in the up-down direction at positions corresponding to the through holes 125 and the notches 126 of the lower housing 12.

The screw holes 115 do not extend through the left side wall 111, the right side wall 112, and the rear wall 113 in a thickness direction. The outer surfaces of the left side wall 111, the right side wall 112, and the rear wall 113 of the upper housing 11 are decorative surfaces.

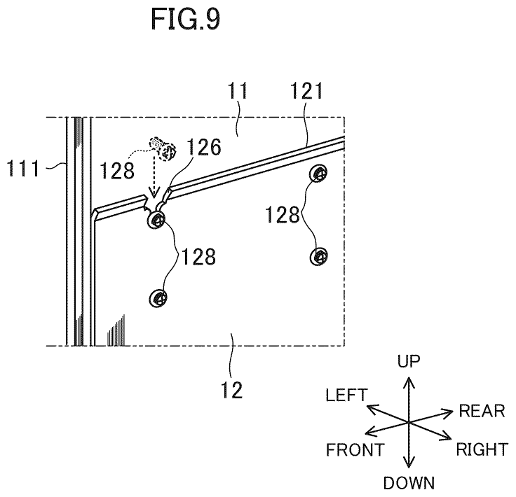

Screws 128 that pass through the through holes 125 of the lower housing 12 are fastened into the screw holes 115 (see FIG. 9). By fastening the screws 128 into the screw holes 115, the upper housing 11 is coupled to the lower housing 12.

FIG. 9 is an enlarged view showing a coupling portion between the upper end of the left side wall 121 of the lower housing 12 and the left side wall 111 of the upper housing 11. When coupling the upper housing 11 and the lower housing 12, as indicated by the dotted arrows in FIG. 8, an operator lowers the upper housing 11 toward the lower housing 12 with the screws 128 temporarily fastened into the screw holes 115 of the upper housing 11. The temporarily fastened screws 128 enter the notches 126 from the upper end of the lower housing 12 and can be engaged with the notches 126 (see the dashed arrow in FIG. 9). By engaging the temporarily fastened screws 128 with the four notches 126 of the lower housing 12, the upper housing 11 can be positioned relative to the lower housing 12 at a desired height position. A state in which the screws 128 are temporarily fastened refers to a state in which the screws 128 are screwed into the screw holes 115 but are not fully tightened, such that the screws 128 protrude inward from the inner surfaces by a sufficient length.

Each notch 126 has a width that is wider on the upper side and narrower on the lower side. This shape of the notch 126 facilitates entry of the temporarily fastened screw 128 into the notch 126.

The upper edge of the left side wall 121 is bent inward toward the inside of the lower housing 12. The upper edges of the right side wall 122 and the rear wall 123 of the lower housing 12 are similarly bent toward the inside of the lower housing 12. When the upper housing 11 is lowered toward the lower housing 12, the bent upper edges facilitate positioning of the left side wall 121, the right side wall 122, and the rear wall 123 of the lower housing 12 inside the left side wall 111, the right side wall 112, and the rear wall 113 of the upper housing 11, respectively. The bent upper edges function as guides for the left side wall 121, the right side wall 122, and the rear wall 123 of the lower housing 12, and improve the ease of assembly of the housing 10.

With the upper housing 11 positioned relative to the lower housing 12, the screws 128 are fastened into the screw holes 115 for all of the through holes 125 and the notches 126 of the lower housing 12. The upper housing 11 is thus coupled to the lower housing 12. In this manner, the notches 126 improve the ease of coupling the upper housing 11 and the lower housing 12.

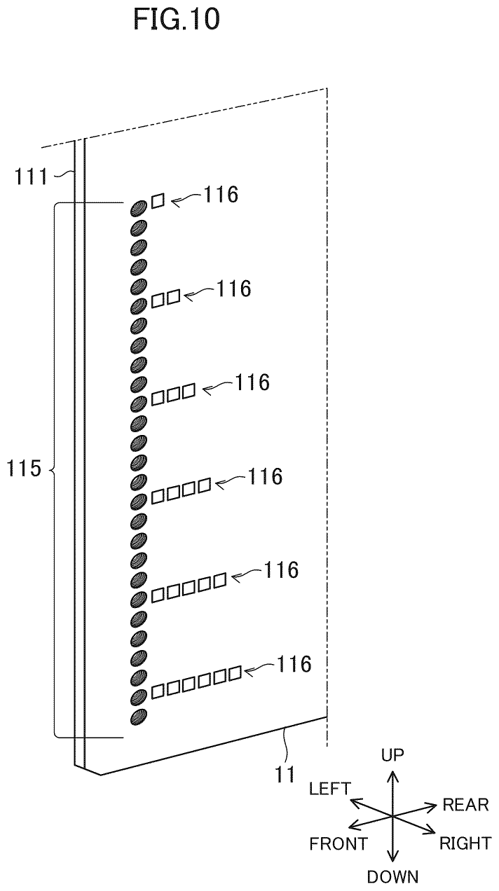

As shown in FIG. 10, each of the left side wall 111, the right side wall 112, and the rear wall 113 of the upper housing 11 is provided with marks 116. The marks 116 are positioned at equal intervals in the up-down direction beside the screw holes 115 arranged in the up-down direction. The marks 116 have different shapes depending on their height positions. By using the marks 116, the operator can temporarily fasten the screws 128 into the screw holes 115 at the same height position in each of the left side wall 111, the right side wall 112, and the rear wall 113. Since the marks 116 are provided beside the screw holes 115 into which the screws 128 to be engaged with the notches 126 are screwed, the operation of coupling the upper housing 11 and the lower housing 12 is facilitated.

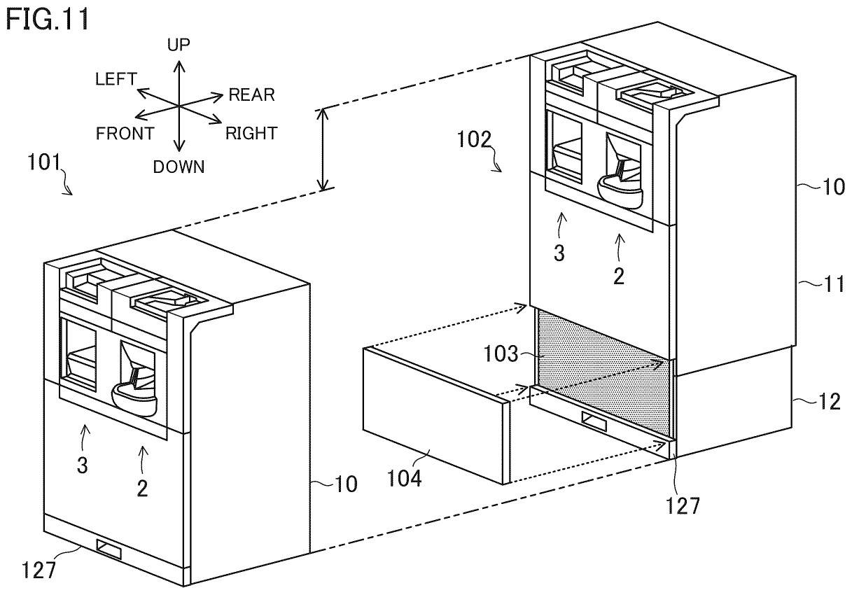

When the screws 128 are fastened into upper screw holes 115 of the upper housing 11, the overall height of the housing 10 becomes relatively low. As shown in FIG. 11, the overall height of the money handling apparatus 101 can be reduced. The money handling apparatus 101 shown on the left side of FIG. 11 has the lowest overall height, and the coin handling unit 2 and the banknote handling unit 3 are directly placed on the slider 127.

When the screws 128 are fastened into lower screw holes 115 of the upper housing 11, the overall height of the housing 10 becomes relatively high. As shown in FIG. 11, the overall height of the money handling apparatus 102 can be increased. The money handling apparatus 102 shown on the right side of FIG. 11 has the highest overall height.

The left side wall 121, the right side wall 122, and the rear wall 123 of the lower housing 12 are positioned inside the left side wall 111, the right side wall 112, and the rear wall 113 of the upper housing 11, respectively, and the screws 128 are fastened inside the upper housing 11 and the lower housing 12. Therefore, the screws 128, the through holes 125, and the screw holes 115 are not exposed outside the housing 10.

When the overall height of the housing 10 is high, a spacer 103 is disposed between the slider 127 and the coin handling unit 2 and the banknote handling unit 3. That is, the coin handling unit 2 and the banknote handling unit 3 are placed on the slider 127 with the spacer 103 therebetween. Accordingly, when the slider 127 is pulled forward, the spacer 103 placed on the slider 127, as well as the coin handling unit 2 and the banknote handling unit 3, can be pulled forward from the housing 10. Even when the overall height of the money handling apparatus 1 is changed, the slider 127 does not lose its function to pull out the coin handling unit 2 and the banknote handling unit 3. With two members, namely the upper housing 11 and the lower housing 12, the structure of the housing 10 described above can accommodate money handling apparatuses 1 having different overall heights.

In a case where the spacer 103 is used, a decorative cover 104 of the spacer 103 is attached to the money handling apparatus 1.

### Interlock Circuit of Money Handling Apparatus

The money handling apparatus 1 is configured by integrating the coin handling unit 2 and the banknote handling unit 3. The coin handling unit 2 and the banknote handling unit 3 include an interlock circuit 5 to ensure safety when the coin handling unit 2 and the banknote handling unit 3 are pulled out from the housing 10. The interlock circuit 5 stops power supply to the coin handling unit 2 and the banknote handling unit 3.

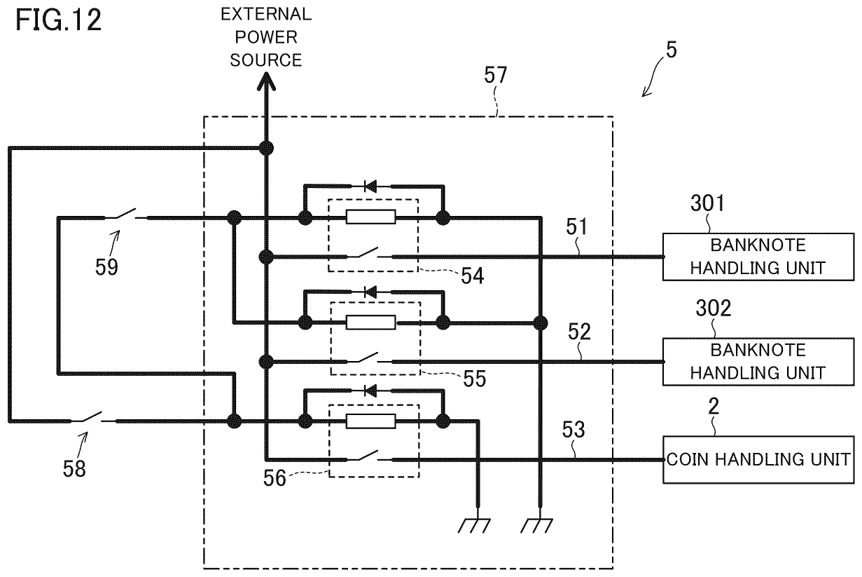

FIG. 12 shows the interlock circuit 5. The interlock circuit 5 includes power supply lines 51, 52, and 53. The power supply line 51 supplies power from an external power source to a banknote handling unit 301. The power supply line 52 supplies power from the external power source to a banknote handling unit 302. The power supply line 53 supplies power from the external power source to the coin handling unit 2. The banknote handling units 301, 302 and the coin handling unit 2 are connected in parallel to the external power source. The banknote handling units 301, 302 are connected in parallel because two units supplied with power from the external power source are provided inside the banknote handling unit 3.

A first relay circuit 54 is interposed in the power supply line 51. A second relay circuit 55 is interposed in the power supply line 52. A third relay circuit 56 is interposed in the power supply line 53. The first relay circuit 54, the second relay circuit 55, and the third relay circuit 56 are mounted on a relay board 57.

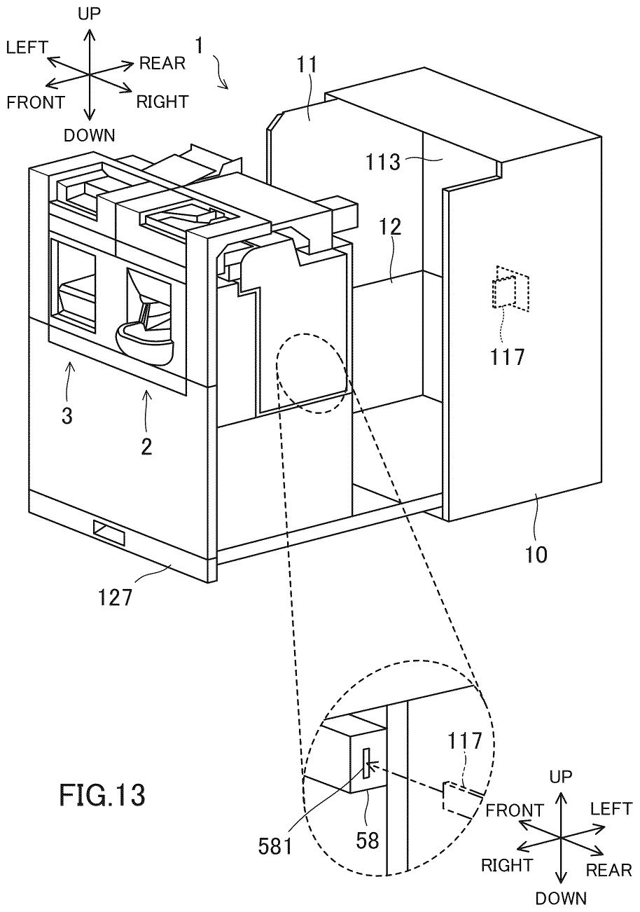

The third relay circuit 56 is connected to the external power source via a first interlock switch 58. As shown in FIG. 13, the first interlock switch 58 is mounted at the rear of the coin handling unit 2 and the banknote handling unit 3 in the money handling apparatus 1. The first interlock switch 58 has a slit 581 opening rearward.

A blade 117 is attached to the inner surface of the rear wall 113 of the upper housing 11. The blade 117 protrudes forward from the inner surface of the rear wall 113. The blade 117 can be inserted into the slit 581 of the first interlock switch 58.

The blade 117 is mounted on the upper housing 11. Even when the relative position between the upper housing 11 and the lower housing 12 is changed and the overall height of the money handling apparatus 1 increases, the relative position between the upper housing 11 and the coin handling unit 2 and the banknote handling unit 3 does not change. Therefore, even when the overall height of the money handling apparatus 1 changes, the functions of the blade 117 and the first interlock switch 58 are ensured.

When the coin handling unit 2 and the banknote handling unit 3 are pulled forward from the housing 10, the blade 117 is withdrawn from the slit 581 of the first interlock switch 58, and the first interlock switch 58 turns off.

When the coin handling unit 2 and the banknote handling unit 3 are housed in the housing 10, as indicated by the two-dot chain arrow in FIG. 13, the blade 117 is inserted into the slit 581 of the first interlock switch 58, and the first interlock switch 58 turns on.

Referring back to FIG. 12, the interlock circuit 5 includes a second interlock switch 59. The second interlock switch 59 is connected in series with the first interlock switch 58. The second interlock switch 59 is interposed between the first interlock switch 58 and the first and second relay circuits 54, 55. The first relay circuit 54 and the second relay circuit 55 are connected to the external power source via the first interlock switch 58 and the second interlock switch 59.

The second interlock switch 59 is located at the mounting portion 38 of the banknote handling unit 3. As shown in FIG. 14, to remove the cassette 37, the operator opens a door 13 of the money handling apparatus 1. The mounting portion 38 is thus exposed. The operator can then remove the cassette 37 by pulling the cassette 37 forward.

As schematically shown in FIG. 3, the cassette 37 mounted in the mounting portion 38 receives power transmitted from the banknote handling unit 3 by engagement between gears of the cassette 37 and the banknote handling unit 3. With this power transmission, the cassette 37 can receive banknotes from the banknote handling unit 3. When the cassette 37 is removed from the mounting portion 38, the gear of the banknote handling unit 3 is exposed in the mounting portion 38. Accordingly, when the cassette 37 is removed from the mounting portion 38, power supply to the banknote handling unit 3 is stopped so as not to rotate the exposed gear, thereby ensuring safety.

As shown in FIG. 3, the second interlock switch 59 is located at the mounting portion 38 of the banknote handling unit 3. When the cassette 37 is mounted into the mounting portion 38, the second interlock switch 59 turns on. When the cassette 37 is removed from the mounting portion 38, the second interlock switch 59 turns off.

As shown in FIG. 13, when the coin handling unit 2 and the banknote handling unit 3 are pulled out from the housing 10 and the first interlock switch 58 turns off, the first relay circuit 54, the second relay circuit 55, and the third relay circuit 56 interrupt conduction of the power supply lines 51, 52, and 53, respectively. As a result, power supply to the banknote handling units 301, 302 and the coin handling unit 2 is stopped.

As shown in FIG. 14, when the cassette 37 is removed from the banknote handling unit 3 and the second interlock switch 59 turns off, the first relay circuit 54 and the second relay circuit 55 interrupt conduction of the power supply lines 51, 52, respectively. As a result, power supply to the banknote handling units 301, 302 is stopped. However, since the first interlock switch 58 is on, the third relay circuit 56 maintains conduction of the power supply line 53, and power supply to the coin handling unit 2 continues. Accordingly, the coin handling unit 2 can operate.

For example, in a case where both banknotes and coins are collected from the money handling apparatus 1, even after the banknotes to be collected are stored in the cassette 37 and the cassette 37 is removed from the banknote handling unit 3, the coin handling unit 2 can perform the collection process described above. Alternatively, the coin handling unit 2 can perform a replenishment process of replenishing the coin handling unit 2 with coins. The interlock circuit 5 stops power supply to the banknote handling unit 3 when the cassette 37 is removed. The interlock circuit 5 also stops power supply to both the coin handling unit 2 and the banknote handling unit 3 when the coin handling unit 2 and the banknote handling unit 3 are pulled out. The interlock circuit 5 can switch between these two states. This is because the first interlock switch 58 and the second interlock switch 59 are connected in series.

Merely opening the door 13 for removal of the cassette 37 does not stop power supply to the coin handling unit 2 and the banknote handling unit 3.

### Interlock Switch in Second Housing

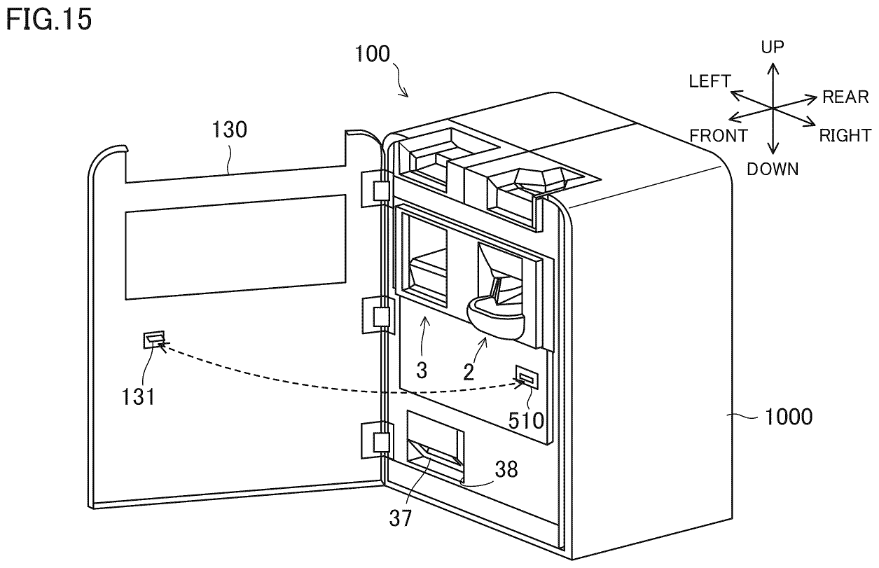

The money handling apparatus can have its housing changed. FIG. 15 illustrates a money handling apparatus 100 including a second housing 1000. The housing 1000 accommodates the coin handling unit 2 and the banknote handling unit 3. Even when the housing is changed, the coin handling unit 2 and the banknote handling unit 3 are substantially unchanged.

The housing 1000 includes a door 130. The door 130, when opened, exposes the front portions of the coin handling unit 2 and the banknote handling unit 3. When the door 130 is opened, the cassette 37 can be removed from the mounting portion 38.

A blade 131 is attached to the rear surface of the door 130. The blade 131 protrudes from the rear surface of the door 130.

An interlock switch 510 is mounted at the front of the coin handling unit 2 and the banknote handling unit 3. When the door 130 is closed, the blade 131 is inserted into a slit of the interlock switch 510, and the interlock switch 510 turns on. When the door 130 is opened, the blade 131 is withdrawn from the slit of the interlock switch 510, and the interlock switch 510 turns off.

The interlock switch 510 corresponds to the first interlock switch 58 in the interlock circuit 5 of FIG. 12. In the interlock circuit of the money handling apparatus 100 of FIG. 15, the second interlock switch 59 is omitted, or the second interlock switch 59 is set to be always on. The interlock circuit can be shared between the money handling apparatus 1 and the money handling apparatus 100.

Therefore, in the money handling apparatus 100 of FIG. 15, when the door 130 is opened, the interlock switch 510 turns off, and power supply to both the coin handling unit 2 and the banknote handling unit 3 is stopped. When the door 130 is closed, the interlock switch 510 turns on, and power supply to both the coin handling unit 2 and the banknote handling unit 3 is started.

As described above, the interlock circuit can be shared between the money handling apparatus 1 and the money handling apparatus 100. By changing the mounting position of the interlock switch, various housings can be applied to a money handling apparatus including the coin handling unit 2 and the banknote handling unit 3.

What is claimed is:

1. A method for controlling a money handling apparatus, the method comprising:
causing the money handling apparatus to store money in a first storage that stores and feeds money;
causing the money handling apparatus to store money in a second storage that stores and feeds money; and
causing the money handling apparatus to selectively perform a first collection process or a second collection process when performing a collection process of collecting money from the money handling apparatus, wherein
the first collection process is a process in which the money handling apparatus dispenses, to an outlet, money fed from the first storage and money fed from the second storage, and
the second collection process is a process in which the money handling apparatus consolidates money in the money handling apparatus into the first storage by moving money from the second storage to the first storage.

2. The method of claim 1, wherein
in the second collection process, the money handling apparatus instructs an operator to remove the first storage after money is moved from the second storage to the first storage.

3. The method of claim 1, wherein
the money handling apparatus stores, in the second storage, money fed from the first storage as money to be dispensed from the outlet in a dispensing process.

4. The method of claim 1, wherein
the money handling apparatus stores, in the first storage, money inserted into an inlet of the money handling apparatus.

5. The method of claim 1, wherein
in the first collection process, the money handling apparatus dispenses, to the outlet, money fed from the first storage after the money is recognized by a recognition sensor, and dispenses, to the outlet, money fed from the second storage after the money is recognized by the recognition sensor, and
the money handling apparatus outputs a counting result obtained by the recognition sensor in the first collection process.

6. The method of claim 1, wherein
in the second collection process, after money is removed from the first storage, the money handling apparatus checks whether the first storage is empty by driving a feeding mechanism of the first storage in a money feeding direction and driving the recognition sensor for a predetermined period of time.

7. The method of claim 2, wherein
before instructing an operation of removing the first storage in the second collection process, the money handling apparatus drives a feeding mechanism of the first storage in a direction opposite to a money feeding direction.

8. The method of claim 1, wherein
before starting the second collection process, the money handling apparatus confirms, based on an inventory amount in the first storage and an inventory amount in the second storage, that the first storage does not exceed a full capacity when money is moved from the second storage to the first storage.

9. The method of claim 1, wherein
in a case where either or both of a denomination and the number of pieces of money t be collected from the money handling apparatus are specified, the money handling apparatus performs the first collection process.

10. The method of claim 1, wherein
in a case where collection of all money in the money handling apparatus is specified, the money handling apparatus performs the second collection process.

11. The method of claim 1, wherein
based on a collection amount of money that is an amount of money to be collected from the money handling apparatus, the money handling apparatus performs the first collection process in a case where the collection amount is less than a predetermined amount, and performs the second collection process in a case where the collection amount is greater than or equal to the predetermined amount.

12. The method of claim 1, wherein
the money handling apparatus stores selection information indicating selection of the first collection process or the second collection process set in advance, and
when execution of the collection process is instructed, the money handling apparatus performs the first collection process or the second collection process in accordance with the selection made in advance.

13. The method of claim 1, wherein
when execution of the collection process is instructed, the money handling apparatus causes an operator to select the first collection process or the second collection process, and
the money handling apparatus performs the first collection process or the second collection process in accordance with selection made by the operator.

14. The method of claim 13, wherein
in a case where the first collection process is selected, the money handling apparatus allows either or both of a denomination and the number of pieces of money to be collected to be specified, and
in a case where the second collection process is selected, all money is collected from the money handling apparatus.

15. A money handling apparatus, comprising:
a first storage that stores and feeds money;
a second storage that stores and feeds money;
an outlet to which money fed from the first storage or the second storage is dispensed;
a transport member that forms a transport path connecting the first storage, the second storage, and the outlet to each other, and that transports money among the first storage, the second storage, and the outlet; and
a controller that outputs a control signal to the first storage, the second storage, and the transport member, wherein
the controller selectively performs a first collection process or a second collection process when performing a collection process of collecting money from the first storage and the second storage;
the first collection process is a process of dispensing, to the outlet, money fed from the first storage and money fed from the second storage; and
the second collection process is a process of consolidating money in the money handling apparatus into the first storage by moving money from the second storage to the first storage.
